(19) United States
(12) Patent Application Publication
(10) Pub. No.: US 2012/0138496 A1
(43) Pub. Date: Jun. 7, 2012

(54) Foldable transport case for items, in particular tool bag

(76) Inventor: Massimo Tonelli, Casalecchio Di Reno (IT)

(21) Appl. No.: 13/261,166

(22) PCT Filed: Aug. 4, 2009
(86) PCT No.: PCT/IT2009/000362

§ 371 Date: Feb. 1, 2012

(51) Int. Cl. A45C 7/00; B25H 3/02; A45C 3/00

(52) U.S. Cl. 206/349

(57) ABSTRACT

A foldable transport case for items, in particular a tool bag, comprising an at least partially rigid bottom, with respect to which walls are articulated, at least one of the walls being at least partially rigid. Suitable means for detachable mutual connection are interposed between the walls in order to arrange the walls in a folded configuration, in which the walls rest on the bottom with minimal overall space occupation, and in a formed configuration, in which the walls are substantially perpendicular to the bottom, delimiting a compartment that is adapted to accommodate items. The container comprises auxiliary coupling elements for the contiguous walls, which consist of at least one strap arranged along the walls and provided with at least one respective buckle in which engagement is automatic and disengagement depends upon the actuation of at least one suitable lever.

The present invention relates to a foldable transport case for items, in particular a tool bag.

### BACKGROUND OF THE INVENTION

Item carrying bags and tool bags are used by technicians and by workers in general as a professional aid.

These bags can be true rigid cases, trunks, or bags made of flexible material depending on the requirements and the characteristics of the application.

Propensity toward bags is motivated by the need to be able to store these containers in small spaces (when they are not used, during shipping and the like): a container made of soft material can in fact be folded up easily in order to minimize its space occupation.

However, a completely flexible container is unsuitable for the easy transport of heavy and bulky tools and utensils and also makes it difficult to protect against impacts any delicate components stored inside it.

The typical advantages of rigid cases and trunks have been applied in a type of special bags, in which the walls have a higher rigidity (due to the insertion of reinforcements along some faces) but are nonetheless mutually articulated by means of materials that are easily flexible, deformable and therefore easily bendable.

Although these bags can be folded up to reduce their space occupation (which in any case is generally greater than the space occupation of an equivalent bag that is instead entirely made of soft and flexible material), they allow easy transport of heavy and bulky objects and preserve against impacts the delicate components stored inside them.

Retention of this type of semirigid bag in the formed configuration (not folded up) is obtained generally by means of elements for mutually connecting their faces.

In particular, it is known to adopt clips, buttons, zip fasteners and strips of material such as Velcro to mutually connect the faces.

Although these connecting elements are convenient to use, they are problematic in terms of the possibility of transporting heavy objects: many working tools and utensils are very heavy, and the mechanical stresses to which they submit the connecting elements are excessive, causing such elements to fail and causing the bag to open, making its entire content fall out.

### SUMMARY OF THE INVENTION

The aim of the present invention is to solve the drawbacks described above, by proposing a foldable transport case for items, in particular a tool bag, that is suitable for the transport of heavy and/or bulky objects.

Within this aim, an object of the invention is to propose a foldable transport case for items, in particular a tool bag, the folding of which is simple and quick to perform and whose final space occupation is minimal.

Another object of the invention is to propose a foldable transport case for items, in particular a tool bag, provided with elements for connecting the mutually disengageable parts/faces which are particularly sturdy and suitable for withstanding intense mechanical stresses and for rapid and safe engagement/disengagement operations.

Another object of the invention is to propose a foldable transport case for items, in particular a tool bag, that is suitable for transporting delicate components by means of a structure that is suitable for protection against impacts.

Another object of the present invention is to provide a foldable transport case for items, in particular a tool bag, that has a low cost, is relatively simple to provide in practice and safe in application.

This aim and these objects, as well as others that will become better apparent hereinafter, are achieved by a foldable transport case for items, in particular a tool bag, of the type that comprises an at least partially rigid bottom, with respect to which walls are articulated, at least one of said walls being at least partially rigid, means for detachable mutual connection being interposed between said walls in order to arrange said walls in a folded configuration, in which said walls rest on said bottom with minimal overall space occupation, and in a formed configuration, in which said walls are substantially perpendicular to said bottom, delimiting a compartment that is adapted to accommodate items, characterized in that it comprises auxiliary coupling means for the contiguous walls which consist of at least one strap arranged along said walls and provided with at least one respective buckle in which engagement is automatic and disengagement depends upon the actuation of at least one suitable lever.

### BRIEF DESCRIPTION OF THE DRAWINGS

Further characteristics and advantages of the invention will become better apparent from the detailed description that follows of a preferred but not exclusive embodiment of the foldable transport case for items, in particular a tool bag, according to the invention, illustrated by way of non-limiting example in the accompanying drawings, wherein:

FIG. 1 is a front elevation view of a transport case for items according to the invention in the formed configuration;

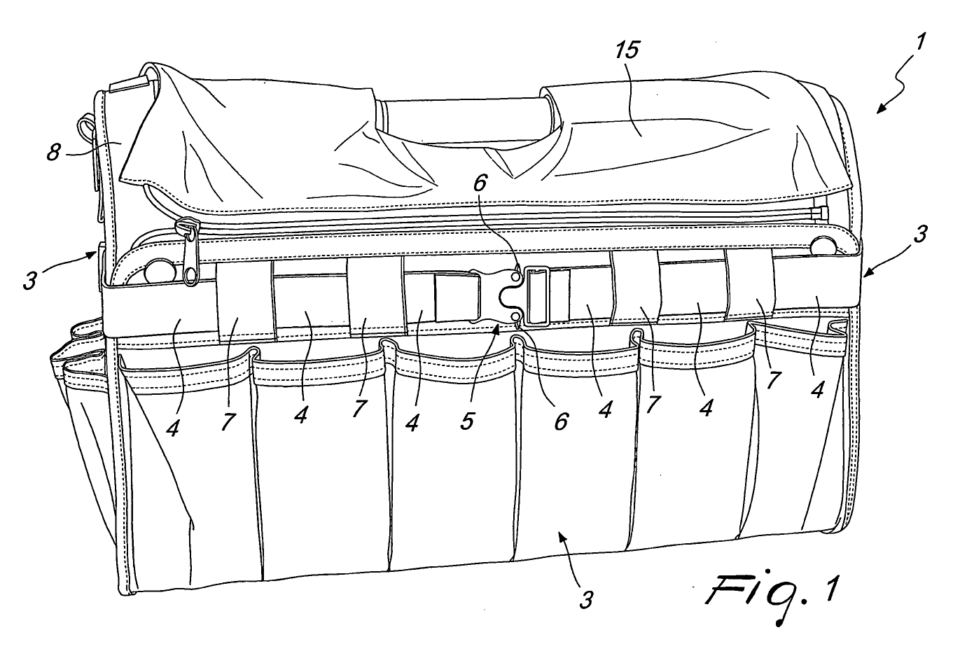

FIG. 2 is a lateral elevation view of the transport case for items according to the invention in the formed configuration;

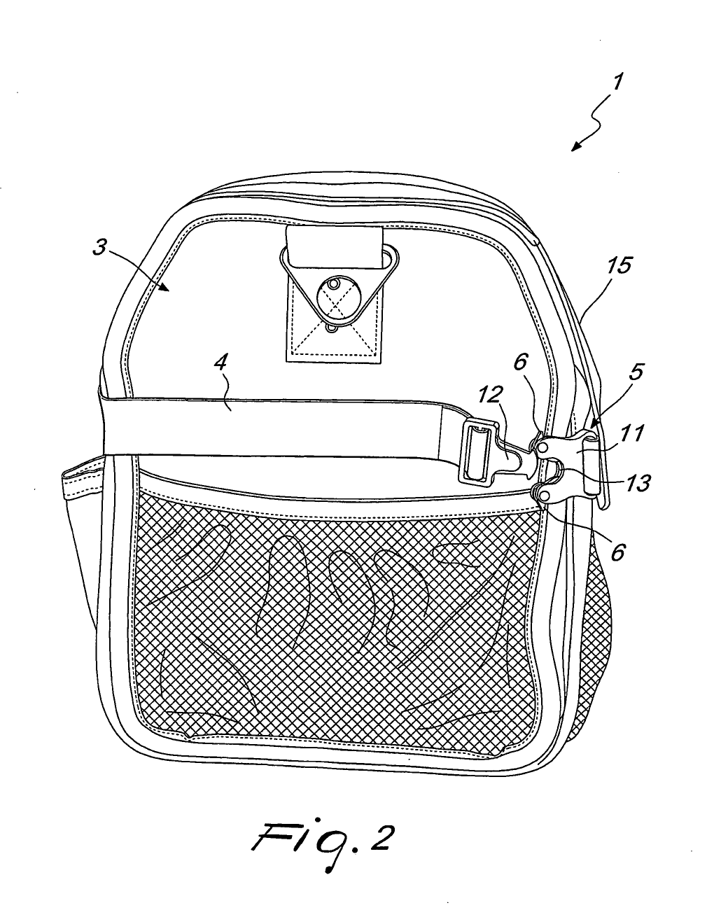

FIG. 3 is a perspective view of a first detail of the transport case for items according to the invention in an only partially formed configuration;

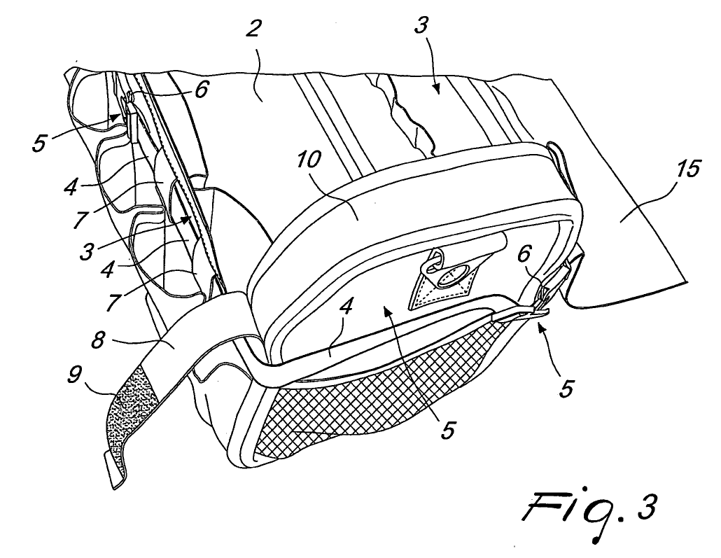

FIG. 4 is a perspective view of a second detail of the transport case for items according to the invention;

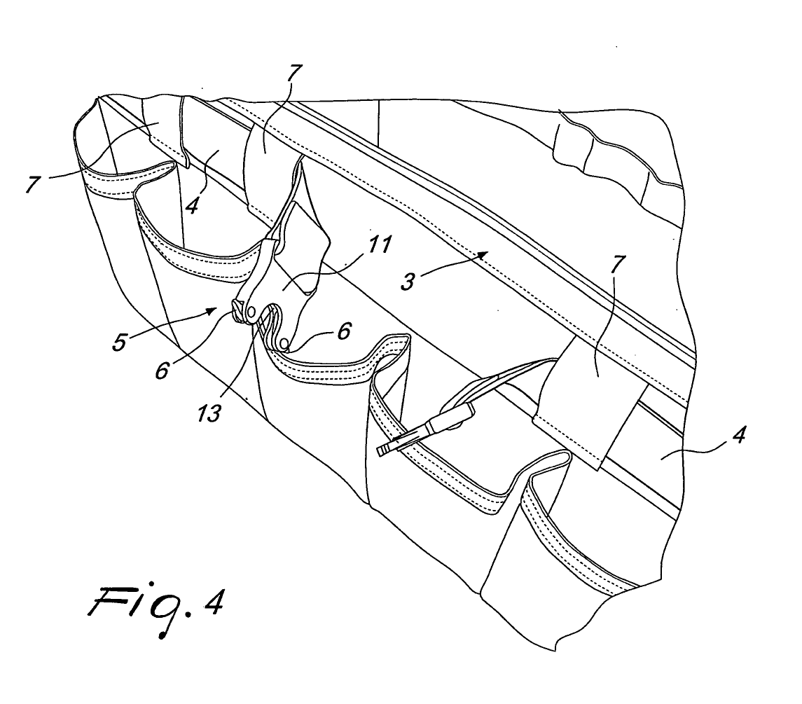

FIG. 5 is a perspective view of a third detail of the transport case for items according to the invention.

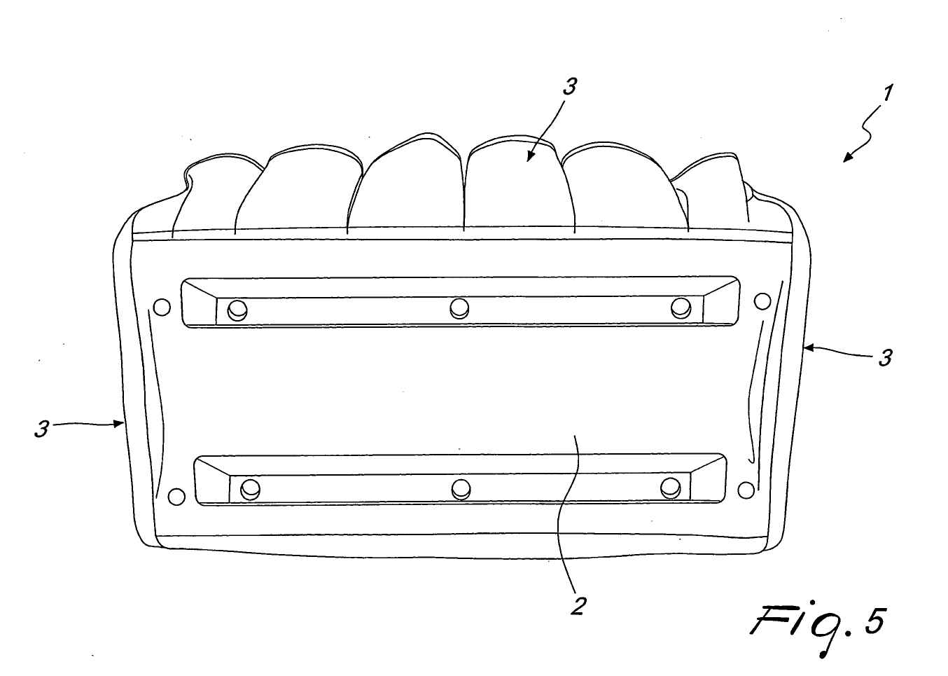

### DESCRIPTION OF THE PREFERRED EMBODIMENTS

With reference to the figures, the reference numeral 1 generally designates a foldable transport case for items, in particular a tool bag.

The transport case for items 1 comprises an at least partially rigid bottom 2.

Walls 3 are articulated with respect to the bottom 2 by means of flaps of fabric or equivalent material which join the bottom 2 to the walls 3.

At least one of the walls 3 is at least partially rigid: in particular, it is convenient for the bottom 2 and the side walls 3 to be rigid in order to provide a container 1 (or a bag) in which the contents are protected against impacts with the outside.

This solution can be achieved by arranging within each wall 3 and the bottom 2 at least one rigid insert: since the walls 3 normally consist of at least two superimposed flaps of fabric, it is simple to interpose between them a rigid insert of variable dimensions (the insert can be as large as the entire wall 3 or it can affect only a minimal part thereof).

The materials adapted to provide this type of insert are numerous; merely by way of example, the possible adoption of plates made of polymeric material, paper-like material and the like is noted.

Suitable detachable means for mutual connection are interposed between the walls 3 in order to arrange said walls in a closed configuration, in which the walls 3 rest on the bottom 2 with minimal overall space occupation, and in a formed configuration, in which the walls are substantially perpendicular to the bottom 2, delimiting a compartment that is adapted to accommodate items.

The container 1 according to the invention comprises auxiliary coupling means for the contiguous walls 3, consisting of at least one strap 4, which is arranged along the walls 3 and provided with at least one respective buckle 5 in which engagement is automatic and disengagement depends on the actuation of at least one suitable lever 6.

In practice, when the container 1 is completely formed (the means for detachable mutual connection of the walls 3 are all mutually connected so that the container 1 is completely formed so as to constitute an internal containment compartment), the at least one strap 4 is fastened (by means of the respective buckles 5) around the walls 3, with the function of a safety coupling to ensure that this configuration is maintained.

Even if the container 1 must be used to accommodate very bulky and heavy tools and utensils (items in general), the mechanical stresses that they produce can in no case cause the accidental opening of the connecting means. The simplicity of the buckles 5 in any case makes it possible at any time to disengage the strap 4 (so that it no longer locks the container 1 in the formed configuration) in order to separate the walls 3 and arrange the container 1 in the configuration for minimal space occupation, with the walls 3 folded onto the bottom 2.

According to a particular embodiment of unquestionable interest in practice and in application, each strap 4 consists of a plurality of segments provided with the respective end buckles 5. When the buckles 5 are mutually mated, the segments are continuously connected to each other, constituting an annular strap 4 whose length is similar to the perimeter of the container 1 that it must surround. It is therefore evident that even if the connecting elements of a known type do not achieve mutual locking of the walls 3 in an optimum manner, retention of the formed configuration will nonetheless be ensured by the presence of the annular strap 4 consisting of the plurality of portions joined together with the respective buckles 5.

In order to ensure that the strap 4, or the segments that constitute it, do not arrange themselves incorrectly with respect to the ideal positioning for a locking of the walls 3, it is convenient for at least one of the walls 3 to have at least one tubular pocket for stable accommodation of at least one respective strap 4.

Ideally, these tubular pockets can also have a minimal extension and be shaped like the loops 7 of a belt.

According to one very strong and stable possible constructive application, the container 1 can also comprise suitable auxiliary straps 8, along the edges of at least one wall 3, which are provided with flaps 9 for quick engagement with respective areas 10 of the edge of a contiguous wall 3.

In particular, the quick engagement flaps 9 and the corresponding areas 10 comprise complementary portions made of a material such as Velcro®. This additional coupling ensures simultaneously greater solidity of the couplings between the walls 3 and perfect alignment thereof (in order to make the flaps 9 and the areas 10 match up, the alignment of the walls 3 must be as precise as possible).

Each buckle 5 is substantially flat and consists of an enclosure 11 and a lamina 12, which are associated with the ends of at least one portion of a respective strap 4.

The lamina 12 can be locked automatically in a receptacle 13 of the enclosure as a consequence of a mated coupling.

In particular, the lamina 12 has a substantially mushroom-like configuration, with the wider portion arranged at the end.

The enclosure 11 comprises a receptacle 13 whose shape and dimensions are complementary with respect to the end of the lamina 12; two levers 6 are elastically kept in interference with respect to the stroke of the end of the lamina 12 along the receptacle 13.

The levers 6 are pivoted about respective axes to the enclosure 11 and elastic units keep them rotated so that they partially block the opening for accessing the receptacle 13.

Entry of the lamina 12 in the receptacle 13 is easy, as a consequence of the sliding of the end of the lamina 12 along a flat surface of the levers 6; exit of the end is instead prevented by the abutment of the end of the lamina 12 against the end edge of the levers 6, which are kept in a position for partially blocking the opening for access to the receptacle 13 by means of the elastic units.

The opening of the buckle 5, which corresponds to the movement of the edges of the levers 6, requires an external action applied by an operator directly on the levers 6.

The means for detachable mutual connection that can be adopted in a container 1 according to the invention in combination with the auxiliary means consisting of the strap 4 and the buckles 5 preferably comprise apparatuses such as buttons, hinges, clips and complementary portions made of a material such as Velcro®.

The possibility is not excluded to provide at least one of the walls 3 with a second face 15 that is articulated thereto on the side opposite to the bottom 2: this second face in practice constitutes the lid for closing the container 1.

If multiple auxiliary faces 15 are provided, the lid of the container 1 also consists of a plurality of mutually associated flaps. Each face 15 can be flexible, rigid or partially rigid/flexible depending on the requirements of application.

The invention thus conceived is susceptible of numerous modifications and variations, all of which are within the scope of the appended claims; all the details may further be replaced with other technically equivalent elements.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the dimensions, may be any according to requirements and to the state of the art.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-9. (canceled)

10. A foldable transport case for items, in particular a tool bag, of the type that comprises an at least partially rigid bottom, with respect to which walls are articulated, at least one of said walls being at least partially rigid, means for detachable mutual connection being interposed between said walls in order to arrange said walls in a folded configuration, in which said walls rest on said bottom with minimal overall space occupation, and in a formed configuration, in which said walls are substantially perpendicular to said bottom, delimiting a compartment that is adapted to accommodate items, further comprising auxiliary coupling means for the contiguous walls which consist of at least one strap arranged along said walls and provided with at least one respective buckle in which engagement is automatic and disengagement depends upon the actuation of at least one suitable lever.

11. The transport case for items according to claim 10, wherein each one of said straps consists of a plurality of segments provided with respective end buckles, said segments, when said buckles are mutually coupled, constituting an annular strap whose length is similar to the perimeter of the container that it is designed to surround.

12. The transport case for items according to claim 10, wherein at least one of said walls has at least one tubular pocket for the stable accommodation of at least one respective strap.

13. The transport case for items according to claim 10, further comprising suitable auxiliary straps along the edges of at least one wall, which are provided with flaps for quick engagement with respective areas of the edge of a contiguous wall.

14. The transport case for items according to claim 11, wherein said quick engagement flaps and said corresponding areas comprise complementary portions made of a material such as Velcro

15. The transport case for items according to claim 10, wherein each buckle is substantially flat and consists of an enclosure and a lamina, which are associated with the ends of at least one portion of a respective strap, said lamina being automatically lockable within a receptacle of said enclosure with a mated coupling, preferably with an elastic action.

16. The transport case for items according to claim 15, wherein said lamina is substantially mushroom-shaped, with the wider portion located at the end.

17. The transport case for items according to claim 15, wherein said enclosure comprises a receptacle whose shape and dimensions are complementary with respect to the end of said lamina and two levers which are kept elastically in interference with respect to the stroke of the end of the lamina along the receptacle, the entry of the lamina in the receptacle being easy as a consequence of the sliding of the end along the surface of a lateral edge of said levers, the exit of the end being prevented by the abutment of the end of the lamina against the end edge of the levers kept in position by means of elastic units, the opening of the buckle, which corresponds to the movement of the edges of the levers, requiring an external action by an operator directly on said levers.

18. The transport case for items according to claim 10, wherein said means for detachable mutual connection comprise apparatuses such as buttons, hinges, clips and complementary portions made of a material such as Velcro®.
